(19) United States
(12) Patent Application Publication
(10) Pub. No.: US 2017/0076618 A1
(43) Pub. Date: Mar. 16, 2017

(54) Physical Object Training Feedback Based On Object-Collected Usage Data

(71) Applicant: Adobe Systems Incorporated, San Jose, CA (US)

(72) Inventors: Kevin Gary Smith, Lehi, UT (US); William Brandon George, Pleasant Grove, UT (US)

(21) Appl. No.: 14/853,661

(22) Filed: Sep. 14, 2015

(51) Int. Cl. G09B 5/02; H04L 29/08

(52) U.S. Cl. CPC G09B 5/02; H04L 67/12

(57) ABSTRACT

User interactions with a physical object are monitored via one or more sensors integrated with the physical object. The sensors collect usage data for the physical object, based on the user interactions. Analyzed usage data is generated from the usage data collected via the sensors in the physical object as well as from usage data for the physical object that is collected by sensors integrated with one or more additional physical objects that are connected to the physical object by a network. Training feedback, based on the analyzed usage data, is then presented to the user in real-time.

### BACKGROUND

Providing training to users of a product typically consists of some combination of manuals, videos, and classes, along with what amounts to trial-and-error use by the user. In addition to their cost and required time commitment, these training methods have varying levels of effectiveness that are difficult to evaluate. A manual or video cannot respond to different levels of user expertise or provide feedback to the user. Live instruction via a classroom or personal instructor can address some of these shortcomings but they are limited by the competence and teaching skill of the instructor, and in most cases are limited to artificial environments like classrooms and practice facilities.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

In accordance with one or more aspects, user interactions with a physical object are monitored via one or more sensors integrated with the physical object. In response to the user interactions, the sensors collect usage data for the physical object. Analyzed usage data for the physical object is generated by analyzing both the usage data collected via the sensors as well as usage data for the physical object collected by sensors integrated with additional physical objects that are communicatively coupled to the physical object via a network. Training feedback is generated, based on the analyzed usage data, and is presented by the physical object in real-time during use of the physical object.

In accordance with one or more aspects, a device includes one or more processors and one or more computer-readable storage media having stored thereon multiple instructions. The multiple instructions, responsive to execution by the one or more processors, cause the one or more processors to obtain analyzed usage data for a physical object and present training feedback generated based on the analyzed usage data. The analyzed usage data is generated by analyzing usage data collected by one or more sensors integrated with the physical object as well as usage data for the physical object collected by one or more sensors integrated with one or more other physical objects communicatively coupled to the device via a network.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an example environment implementing physical object training feedback based on object-collected usage data in accordance with one or more embodiments.

FIG. 2 is an example embodiment of physical object training feedback based on object-collected usage data in accordance with one or more embodiments.

FIG. 3 is another example embodiment of physical object training feedback based on object-collected usage data in accordance with one or more embodiments.

FIG. 4 is a block diagram illustrating an example physical object implementing physical object training feedback based on object-collected usage data in accordance with one or more embodiments.

FIG. 5 is a flowchart illustrating an example process for physical object training feedback based on object-collected usage data in accordance with one or more embodiments.

FIG. 6 illustrates an example system generally that includes an example computing device that is representative of one or more computing systems and/or devices that may implement the various techniques described herein.

### DETAILED DESCRIPTION

Since the invention of the wheel, product manufacturers have been training their customers how to use their products. Training often consists of manuals, classes, in-person training, and other tedious approaches. Not only can these training methods be tedious, but in many cases it is difficult or impossible to judge the efficacy of the training. The manual writer does not know whether the manual was understood or if product usage improved based on reading of the manual. A class teacher can grade and a personal trainer can observe, but they are limited to their ability to adequately judge, their own skill level, and the effort they put into evaluation. Computer products have the ability to augment these training methods with tool-tips and other in-product training mechanisms. More advanced in-product training tools for computer products would actually base training on the activities, behaviors and usage patterns of the user. However, this approach has never been available to real-world products such as chairs and garage doors.

Physical object training feedback based on object-collected usage data is discussed herein. The physical objects (also referred to as products or devices) are part of the internet of things (IoT), which is a network of physical objects (“things”) that can communicate with one another via a network. The physical objects include embedded sensors and other components, which enable the objects to directly train the user of the object using the techniques discussed herein. A user's interaction with IoT-enabled objects is monitored by the sensors integrated with the objects and optionally by other network-connected resources, such as a smart phone or other computing device. Over time, usage data collected by the sensors in the objects is used to characterize a user's interaction with the object. Usage data can include any kind of information associated with the user's interaction with the physical object, such as the user's posture while using the object, the angle or orientation in which the user holds the object, the speed or duration of the interaction, physical attributes of the user during the interaction (e.g., respiration rate or temperature), and so forth. The usage data is analyzed and based on this analyzed usage data the object, or a related object or computing device, provides training feedback to the user to improve the user's experience with the object.

By connecting physical objects to the IoT, the physical objects themselves can become the trainers and teachers. Much like the computer applications, physical object sensors allow real world physical objects like fish tanks and power tools to teach users how to use them based on the user's actual usage and behavior. Physical objects can have sensors embedded in them that not only collect usage data, but have also been programmed with benchmark data and have the ability to compare your usage to the benchmark data and give training feedback that will help correct user error and teach advanced techniques. Unlike human trainers, the sensors can all provide the same high level of training feedback, and can be updated with additional training data based on the needs of the user.

Further, while a trainer can give general instruction based upon observation and experience, sensors that are connected to the IoT can collect information about large numbers of users and the techniques that improve the users' performance with an object. The data can be aggregated and used to provide training feedback to help improve a particular user's results based on data from other users who use the object in the same way. The actual training feedback may be provided in many ways. Some include training feedback directly from the product through voice, screen, LED (light-emitting diode), or other methods. Other products may communicate with mobile devices, televisions, reading tablets, or other network based output devices to present the training feedback.

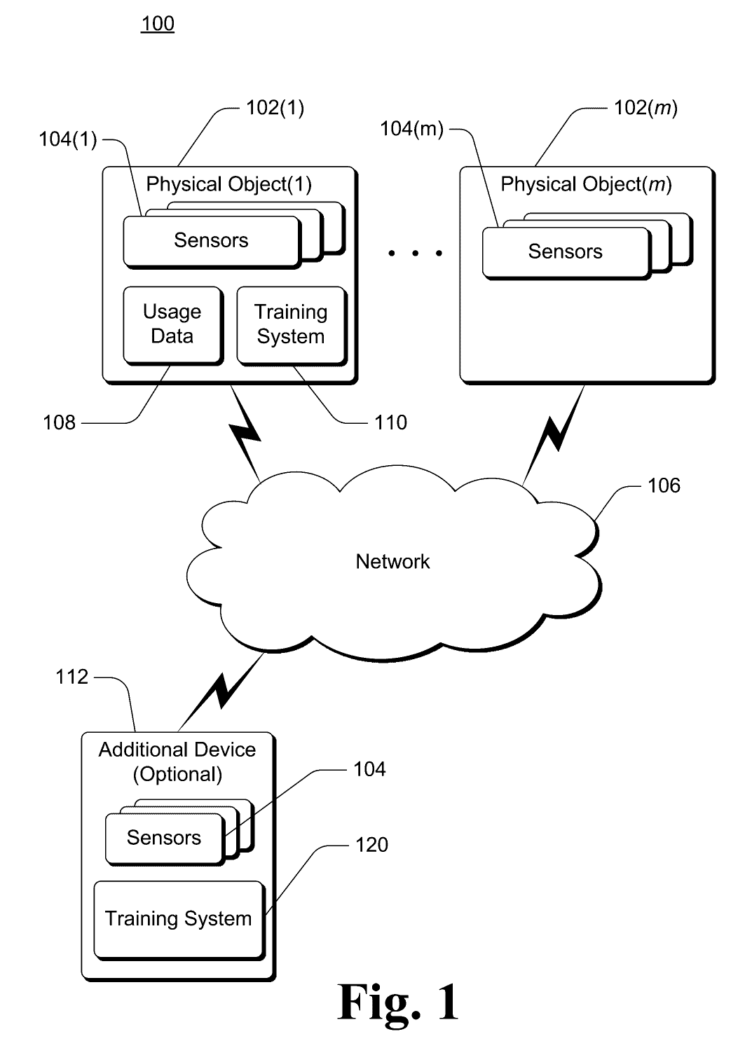

FIG. 1 illustrates an example environment 100 implementing physical object training feedback based on object-collected usage data in accordance with one or more embodiments. Physical objects 102(1)-102(m) can be any of a variety of different objects, including, but not limited to, tools, medical devices, recreational equipment, clothing, household appliances, and computing devices. Each physical object 102 includes one or more sensors 104 integrated with the object. The physical objects 102 are communicatively coupled to one another, and to each of the other objects 102, by a network 106. Usage data 108 is collected by one or more of the sensors 104. Any of physical objects 102(1)-102(m) may also include a training system 110.

The sensors 104 can be any of various types of sensors, such as force transducers, accelerometers, gyroscopes, thermometers, and so forth. A physical object 102 can include a single sensor or multiple sensors of the same and/or different types. Different physical objects 102 can have the same and/or different types of sensors 104. Network 106 can be any of a variety of wired or wireless connections, including any of a variety of different networks, such as the Internet, a local area network (LAN), a personal area network (PAN), a phone network, an intranet, other public and/or proprietary networks, combinations thereof, and so forth. The usage data 108 that is collected by the sensors can vary according to the nature of the particular object 102, but is generally information about a user's interaction with the object that can be used to provide training feedback to the user. The training feedback is provided by training system 110 according to one or more embodiments as described herein.

In one or more embodiments, the training system 110 receives usage data 108 from the physical objects 102 and analyzes the usage data to generate analyzed usage data. The analyzed usage data is usage data that has been processed so that it can be used to generate training feedback. For example, the usage data may have statistical techniques applied to it, may be normalized to account for differences in collection duration or skill level, may be converted to a different measurement system (e.g., ounces versus grams), and so forth. The training system 110 evaluates the analyzed usage data, such as by comparing the analyzed usage data with a particular set of benchmark data, applying various rules or criteria to the analyzed usage data, applying various programs or algorithms to the analyzed usage data, and so forth. This evaluation allows the training system to determine training feedback to be presented to a user (e.g., reveals the similarities and differences between the analyzed usage data and the benchmark data).

The physical object 102 itself can then train the user by providing the training feedback directly from the physical object 102, allowing the user to improve his or her proficiency with the object. This feedback is provided in real-time as the user is using the physical object 102. The training feedback can take multiple forms and have various objectives. For example, the physical object 102 may monitor the user's technique and provide training feedback in real-time (while the physical object 102 is in operation) to enable the user to more effectively use the physical object 102 or to provide training regarding proper techniques for safely using the physical object 102. In other implementations, the physical object 102 may collect usage data while the physical object 102 is in use, or after the use is completed, and subsequently analyze the data with reference to a particular user's prior performance or relative to known performance benchmarks to provide after-the-fact training. Other embodiments may provide the training via another physical object or device, such as an accessory object or computing device. The training may be provided in one or more formats, including text, audio, video, kinesthetic (haptic) feedback, and so forth.

In one or more embodiments, users may choose to receive different aspects of training feedback (e.g., error-correction versus advanced technique training) or elect not to receive any training feedback. In some implementations, a training mode is user-selectable. Selection of the training mode can be implicit consent to collect and analyze usage data, or the user may require the object to obtain affirmative consent before activating the training mode. Unlike human trainers, IoT-enabled objects provide consistent, high quality training feedback, based on the user's actual experience with the physical object in real-time. Additionally, the physical object may be enabled to recognize different users, so training can be customized for a particular user by accessing usage data associated with the particular user.

It should be noted that the information (e.g., benchmark data, rules, criteria, algorithms, etc.) used to evaluate the analyzed usage data may be provided from multiple sources. For example, the training system 110 may have pre-installed, manufacturer-provided information for particular activities or the training system 110 may use the network to retrieve the information from the manufacturer or another source.

In other embodiments, the training system 110 may enable the user to create customized benchmark data from scratch or from other sources selected by the user. For example, a user may allow the training system 110 to store the collected usage data and make it available to other users of the same or similar devices. Training system 110 can aggregate the usage data (e.g., the analyzed usage data) from different users to create benchmark data that can be cross-referenced by various factors (e.g., the particular device, the particular task being attempted, the height and/or weight of the user, and so forth). The training system 110 can aggregate the usage data in different manners, such as by applying different public and/or proprietary machine learning techniques to usage data from different users (of the same or different physical objects) to determine what factors lead to specific results and thus determine the appropriate benchmark data. In this way, a large pool of usage data from different users can become another source of benchmark data. The training system 110 can then provide training feedback based upon the aggregate usage benchmark data, thereby teaching the user how to better use the object based upon usage data about other users with similar characteristics and usage profiles. For example, based on usage data collected from other users having the same approximate height and weight as a particular user and using a same particular golf club as the particular user, the user's golf club can provide training feedback to teach the user how a person of the user's height and weight and general abilities can improve his or her performance with that exact golf club.

The training system 110 optionally allows different users to be identified and allows users to determine, for each use, whether to permit the physical objects to monitor the usage and collect data. Various methods may be used to authenticate the user's selections, including, but not limited to, username and password combinations or biometric identifiers such as a thumbprint reader. These authentication methods may be used with the physical object 102 and/or a computing device, depending on the particular implementation. Different usage data can also be maintained for different users of a physical object 102, allowing different training feedback for the same physical object 102 to be provided to different users.

The example environment 100 optionally includes an additional device 112, which optionally includes one or more sensors 104. The additional device 112 may be another object similar to the physical objects 102 or a computing device (e.g., a tablet computer or a smart phone). The additional device 112 can be connected to network 106 and thereby communicate with the physical objects 102. The additional device 112 may include the training system 120 that can perform the usage data analysis and training feedback functions as described with respect to the training system 110 integrated with the physical object 102. Additionally or alternatively, the additional device 112 may perform the usage data analysis and then send the analyzed usage data to any of physical objects 102 to present training feedback to the user. Thus, the usage data can be analyzed by resources integrated with the physical object 102 being used, by another object or device connected to the physical object 102, by network-based resources, or some other resource in communication with the physical object 102.

By way of example, we might not immediately think that a chair requires much training or that it can provide much training feedback. However, many people spend an increasing amount of time sitting in a chair and looking at a computer monitor. By integrating sensors with chairs and connecting them to the IoT, the chair itself can teach the user to have proper posture and remind the user to take appropriate breaks. The chair can communicate over a network with the desk and the computer monitor to determine whether the user is sitting at the proper distance and height with respect to the monitor. Additionally, these connected physical objects can verify that the monitors and keyboards are angled and placed appropriately to mitigate the negative effects of sitting all day. This training feedback can be provided in real-time, while the user is sitting in the chair. If the user slouches in the chair or has been sitting too long without a break, the chair (or another device) can provide training feedback to remind the user to sit properly or take a short break. Other embodiments of physical object training feedback based on object-collected usage data are described herein, including training provided by power tools, exercise gear, and musical instruments.

By way of another example, although a mobile computing device can be used to record a tennis player's serve so that it can be evaluated later, such a recording is not nearly as useful as having the tennis racquet itself evaluate the serve while the serve is being performed. The training can be further improved by using sensors in accessories such as the ball, the net, or the playing surface that tell the user how fast the serve was, how close to the net, and where it landed. Being able to serve the ball 100 times and having the racquet tell the user which motions made the serve faster or more accurate cannot be accomplished by swinging a smart phone.

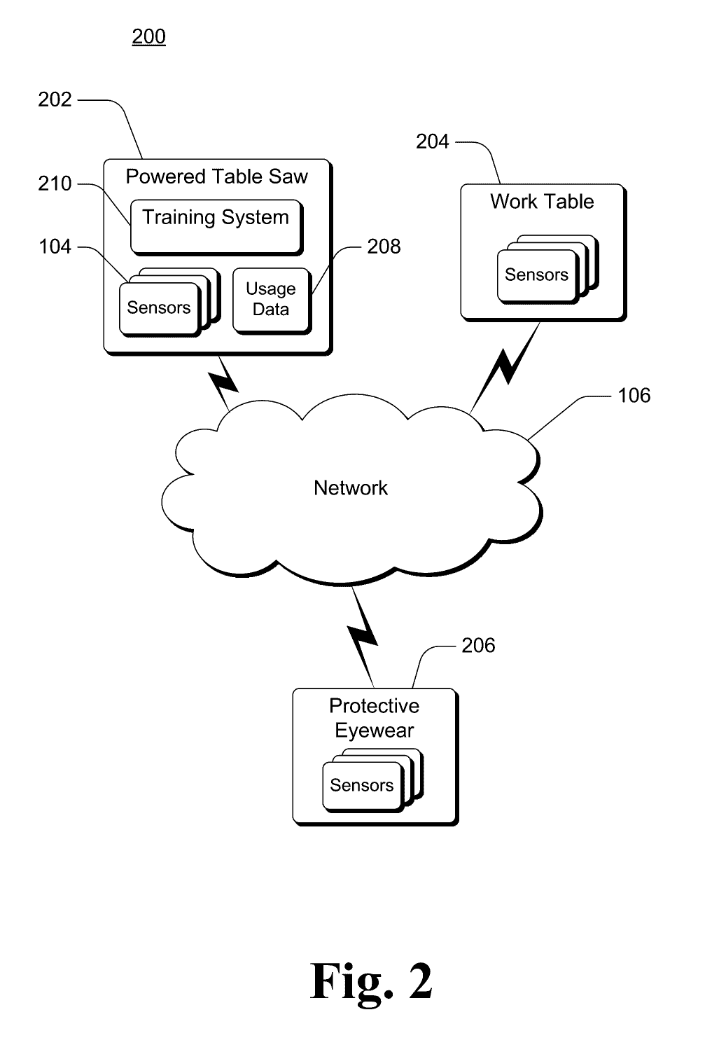

FIG. 2 illustrates an example embodiment 200 of physical object training feedback based on object-collected usage data. The example embodiment 200 illustrates physical objects that include a powered table saw 202, a work table 204, and protective eyewear 206, each of which includes one or more sensors 104. The table saw 202 also includes usage data 208 and a training system 210, which can be the same as the training system 110 depicted in FIG. 1. The sensors 104 integrated with the table saw 202 can monitor the operation of the saw to provide training feedback regarding efficient usage, safety, and so forth. It should be noted that each of the work table 204 and the protective eyewear 206 can, analogous to the powered table saw 202, optionally include usage data and/or a training system.

For example, if the training system 210 receives information regarding the quality of the blade and the material to be cut, velocity or temperature sensors can be used to notify the user if the cut is being performed too fast to make a good cut or if the material is too hard or dense for the blade. Pressure sensors in the cutting guides and hand grips can provide the usage data 208 to the training system 210 that can be used to determine the user's grip and technique. The training system 210 can then compare this usage data with benchmark values to provide training feedback if the user is not holding the saw properly or applying sufficient and consistent pressure.

Additionally or alternatively, the training system 210 can also use other information, such as the power rating of the saw motor or the material of the blade, to teach a user proper techniques to prevent damaging the motor or the blade. In other embodiments, the user may provide information about a series of cuts to be made and the training system 210 can use velocity, motion, and pressure sensors to assist the user in making accurate cuts. Other sensors in the saw's grip and safety mechanism may detect that the saw has ceased operation and alert a user if the safety is not activated. Via connection with the network 106, sensors in the saw may become aware of weather conditions such as rain or lightning that could make operation of the saw unsafe and notify the user of the safety concern or even turn off the saw.

The connection between the saw and other physical objects, via the network 106, also enables additional training feedback. For example, still referring to FIG. 2, an accelerometer or electronic level sensor in the work table 204 can monitor the table and provide usage data regarding the stability of the table to the training system 210. If the usage data indicates that the table changes position in excess of a defined threshold, the training system 210 can give the user training feedback indicating that the table is not stable.

The training system 210 can also present training feedback reminding the user to use proper safety equipment. For example, as shown in FIG. 2, if the user has IoT-enabled protective eyewear 206, the eyewear 206 itself could sense whether it is being used and provide that information to the training system 210 to notify the user. Additionally or alternatively, the training system 210 may attempt to communicate with the protective eyewear 206 and present training feedback alerting the user if no connection is available, as this may indicate the user is not wearing the protective eyewear 206 or that the eyewear 206 is not connected to the training system 210. In other embodiments, the table saw 202 may include an integrated camera with facial recognition functionality that could monitor the user and the training system 210 can present training feedback notifying the user to wear safety glasses if the user does not appear to be wearing safety glasses.

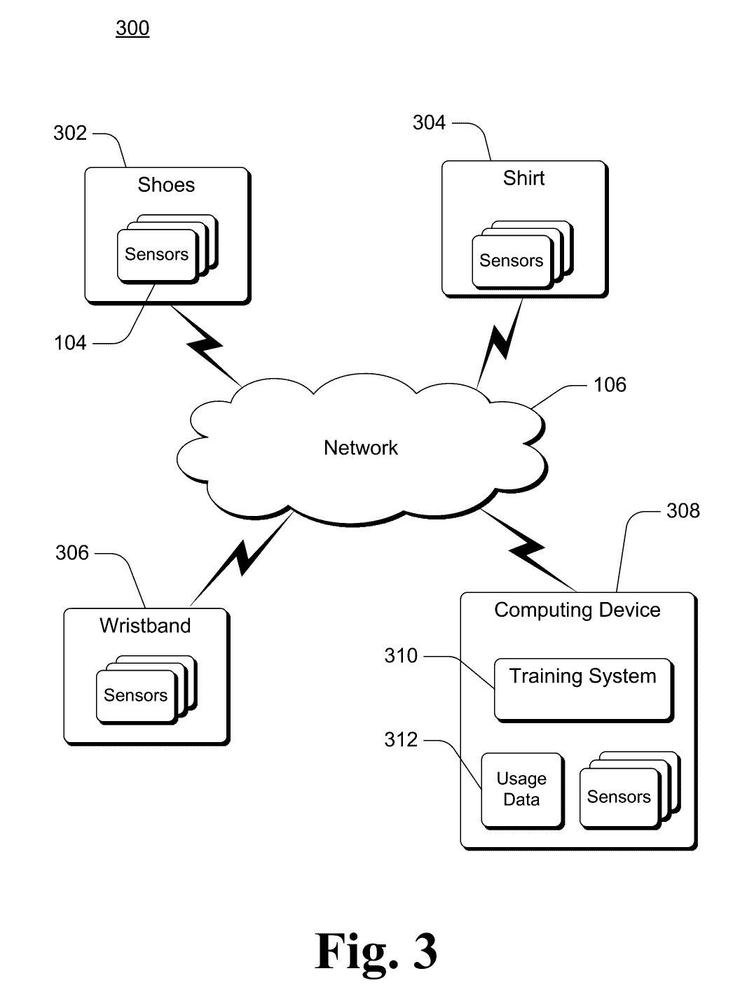

FIG. 3 illustrates another example embodiment 300 of physical object training feedback based on object-collected usage data. The example embodiment 300 illustrates physical objects worn by a user, which include shoes 302, a shirt 304, a wristband 306, as well as a computing device 308. The computing device 308 includes a training system 310 and usage data 312. The training system 310 can be the same as training system 110 of FIG. 1 and/or the training system 210 of FIG. 2. Each of the physical objects of the example embodiment 300 may include one or more sensors 104. The sensors 104 integrated with the physical objects 302-308 can monitor the user's interactions with the physical objects while the physical objects are in use to provide analyzed usage data to the computing device. The computing device 308 provides training feedback to the user regarding efficient usage, health indications, and so forth.

For example, the sensors 104 in the shoes 302 can include a network of force and motion sensors. These sensors can be configured to provide usage data to the training system 310 that enables the training system 310 to provide training feedback. In one implementation, the sensors 104 can measure the user's weight distribution on the shoes 302. This usage data can be analyzed, and the training system 310 can then compare the analyzed usage data to benchmark data and provide feedback to train the user to have correct posture. In other implementations, the sensors 104 and training system 310 can accurately measure the user's gait and the training system 310 can provide training feedback to assist a user preparing for a long distance run, implementing physical therapy after an injury, and so forth. Still other implementations may employ sensors that allow the training system 310 to count steps or measure the distance traveled and provide this information to the user.

The connection between the shoes 302 and other physical objects, via the sensors 104 and the network 106, also enables the training system 310 to provide additional training feedback. For example, sensors integrated with the shirt 304 can monitor various physical attributes of the user, such as the user's respiratory function, and provide usage data regarding the user's physical condition to the training system 310. The sensors in the shoes 302 can also communicate usage data to the training system 310, and the usage data from both the shoes 302 and the shirt 304 can be analyzed by the training system 310 to characterize the user's activity and physical status. The training system 310 can compare the analyzed usage data with benchmark data to provide training feedback (e.g., alerts) to the user. Additionally or alternatively, the abovementioned embodiment for achieving proper posture and gait could be combined with this example to train a user to perform the activity with the proper form and intensity, thus achieving the physical goals while reducing the likelihood of injury or pain from improper form.

Additionally or alternatively, the wristband 306 may include integrated sensors to monitor physical characteristics, such as body temperature, and provide usage data regarding the user's physical condition to the training system. The sensors in the shoes 302 can also communicate usage data to the training system 310, and the training system 310 can analyze the usage data from both the shoes 302 and the wristband 306 to characterize the user's activity and physical status. The training system 310 can compare the analyzed usage data with benchmark data to provide training feedback (e.g., alerts) to the user.

Various other scenarios are contemplated. For example, consider a violin that includes integrated sensors that can determine the user's hand and finger position as well as the placement and pressure of the user's fingers on the fingerboard. The bow also includes sensors that can detect the user's hand position and the pressure and velocity exerted on the strings by the bow. A sensor in another physical object (e.g., a smart phone, a metronome, or a tuner) can determine what notes are being played. As the user practices or plays, the sensors can collect usage data and send it to a training system integrated with one of the physical objects. The training system can analyze the data and compare the analyzed usage data with benchmark data, and provide training feedback to the user. The training feedback could include information regarding the accuracy of notes that are being played (pitch, sustain, tempo, vibrato, and so forth). If the benchmark data included the particular version of the composition being played, the training system could provide training on pressure, velocity, and hand position to help the user play the piece in the style of the benchmark performance. Additionally or alternatively, the physical objects of this example could be combined with other physical objects (such as a chair and/or shoes) to provide training feedback regarding the violinists posture.

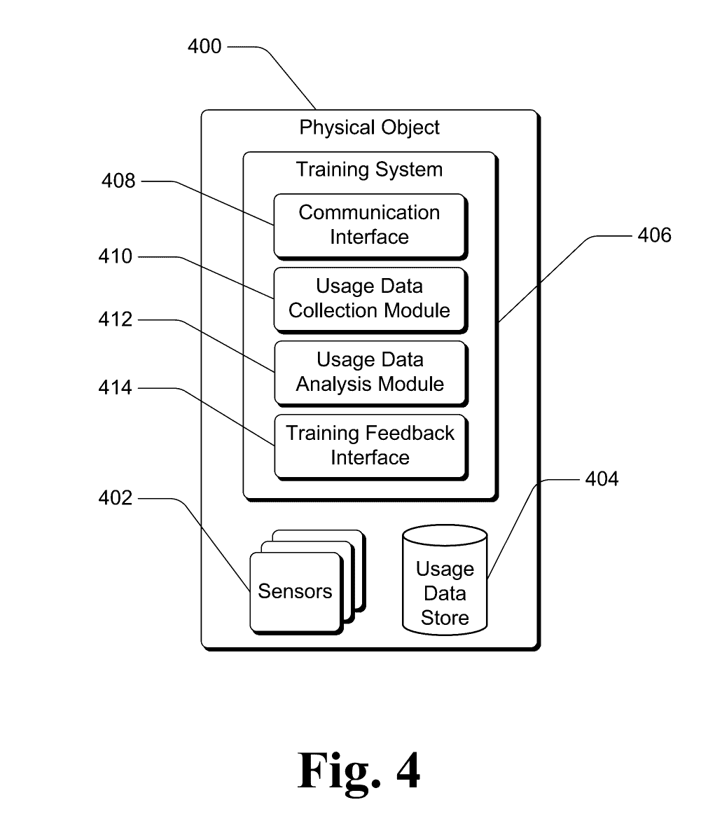

FIG. 4 is a block diagram illustrating an example physical object 400 implementing physical object training feedback based on object-collected usage data in accordance with one or more embodiments. The example physical object 400 can be a variety of different types of objects as discussed above. The physical object 400 may range from a passive object with little intrinsic interactive capability (e.g., a chair or shoe) to a complex item with multiple inputs (e.g., power tools or musical instruments).

The example physical object 400 includes sensors 402, a usage data store 404, and a training system 406. The sensors 402 can be any of various types of sensors, such as thermal sensors, pressure sensors, accelerometers, gyroscopes, and so forth. The usage data store 404 represents memory/storage capacity associated with one or more computer-readable media. The usage data store 404 may include volatile media (such as random access memory (RAM)) and/or nonvolatile media (such as Flash memory, optical disks, magnetic disks, and so forth).

The training system 406 includes a communication interface 408, a usage data collection module 410, a usage data analysis module 412, and a training feedback interface 414. The communication interface 408 receives and transmits data to enable the training system 406 to communicate with other devices and objects. For example, the communication interface 408 may receive data from the sensors 402, the usage data store 404, or from another physical object via a network. Additionally, the communication interface 408 may transmit data to other modules in the training system or to the usage data store 404, other physical objects, and so forth.

In some implementations, the communication interface 408 receives user inputs from a user of the example physical object 400. User inputs can be provided in a variety of different manners, such as by physically interacting with a user interface on the physical object, or by pressing one or more keys of a controller (e.g., remote control device, mouse, trackpad, etc.) of the physical object 400. User inputs can also be provided via other physical feedback input to the physical object 400, such as an action that can be recognized by a motion detection component, an audible input to a microphone, a motion of hands or other body parts observed by an image capture device, and so forth.

The usage data collection module 410 receives usage data from one or more of the sensors 402 in the example physical object 400, sensors in other physical objects or computing devices, and/or other data sources in communication with the training system 406 (e.g., Internet-based data stores, data in local user history, and so forth). The usage data collection module 410 may also transmit data to the usage data analysis module 412 for analysis. The usage data collection module 410 can be configured to be activated automatically when the physical object 400 is used or at other times (e.g., only when authorized by the user of the physical object 400). The user can also select the types of data the usage data collection module 410 collects or enable the usage data collection module 410 to collect all the usage data it is capable of collecting.

The usage data analysis module 412 receives usage data from the usage data collection module 410 and generates, manages, and/or outputs analyzed usage data. The usage data analysis module 412 performs various operations on the usage data and transmits the analyzed usage data to the training feedback interface 414. Additionally or alternatively, the usage data analysis module 412 may receive the usage data already partially or fully analyzed by another physical object and/or transmit the analyzed usage data to another module or to a separate physical object or computing device. Thus, usage data may be collected from, and analyzed by, the same or separate physical objects (and/or other devices).

The usage data analysis module 412 can generate the analyzed usage data by analyzing the received usage data in any of a variety of different manners. The received usage data can be combined (e.g., averaged), normalized, converted to a different measurement system, and so forth. Additionally or alternatively, the usage data can be analyzed (e.g., by the one or more sensors collecting the usage data) prior to being received by the usage data collection module 410.

The analyzed usage data is then evaluated to determine what training feedback to present. The training feedback can be determined by, for example, the usage data analysis module 412 and/or the training feedback interface 414. The training feedback is determined so as to provide an indication to a user of how to improve his or her proficiency with the physical object. For example, the training feedback can be an indication to hold the physical object at a different angle, move the physical object quicker or slower, move the physical object in a particular trajectory, and so forth. The analyzed usage data can be evaluated in various manners, such as by comparing the usage data to various benchmarks or thresholds, applying various programs or algorithms to the usage data, applying various rules or other criteria to the usage data, and so forth.

The benchmarks or thresholds refer to specific values or ranges for the analyzed usage data to be in. For example, if the analyzed usage data is an average rotational speed of a blade over a particular period of time (e.g., ten seconds), then the benchmark or threshold can be a particular speed that the average rotational speed of the blade should be above or below, a range that the average rotational speed of the blade should be within, and so forth.

The rules or criteria refer to various different logical formulas that are evaluated, combinations of benchmarks or thresholds, and so forth. For example, if the analyzed usage data is an average rotational speed of a blade over a particular period of time (e.g., ten seconds) and an indication of whether protective eyewear is sensed by a saw, then the rules or criteria can be that the eyewear is to be sensed by the saw if the average rotational speed of the blade exceeds a particular speed.

The programs or algorithms refer to any of a variety of different functions, procedures, algorithms, and so forth that can be applied to the analyzed usage data. For example, if the analyzed usage data includes various averaged usage data over a particular period of time (e.g., 30 seconds) from shoes, a headband, and a shirt worn by a user while running, various functions, procedures, or algorithms can be applied (as desired by the user or a developer of the training system) to determine what, if any, training feedback is to be presented to the user.

In one or more embodiments, the usage data (and/or analyzed usage data) is maintained in the usage data store 404 over an extended period of time, such as days, weeks, or months. This allows training feedback to be determined based on the usage data over the extended period of time.

Additionally, in one or more embodiments, the usage data (and/or analyzed usage data) for multiple different users is maintained in the usage data store 404 concurrently. This allows different training feedback to be generated for each of the multiple different users, customizing the training feedback as appropriate for the particular user. For example, the training feedback generated for a particular user of a particular physical object can be to move the physical object quicker, and the training feedback generated for a different user of that particular physical object can be to move the physical object slower. Thus, the training feedback is customized to the needs of the individual users.

The training feedback interface 414 provides training feedback to the user (e.g., in response to receiving analyzed usage data). Training feedback can be provided in various formats. For example, the training feedback can be displayed as audio, text, and/or video on a display integrated with the physical object or on a display of a separate device (e.g., the computing device 308 as shown on FIG. 3). Additionally or alternatively, the training feedback can be kinesthetic (haptic) feedback provided by the physical object or another object, other visual feedback (e.g., LED) provided by the physical object or another object, and so forth.

Although particular functionality is discussed herein with reference to particular interfaces, system, or modules, it should be noted that the functionality of individual interfaces, systems, or modules discussed herein can be separated into multiple interfaces, systems, or modules, and/or at least some functionality of multiple interfaces, systems, or modules can be combined into a single interface, system, or module. Further, while the interfaces, systems, and modules are shown integrated with the training system 406, one or more of the interfaces, systems, or modules could be integrated with a training system or module that is part of another physical object or computing device.

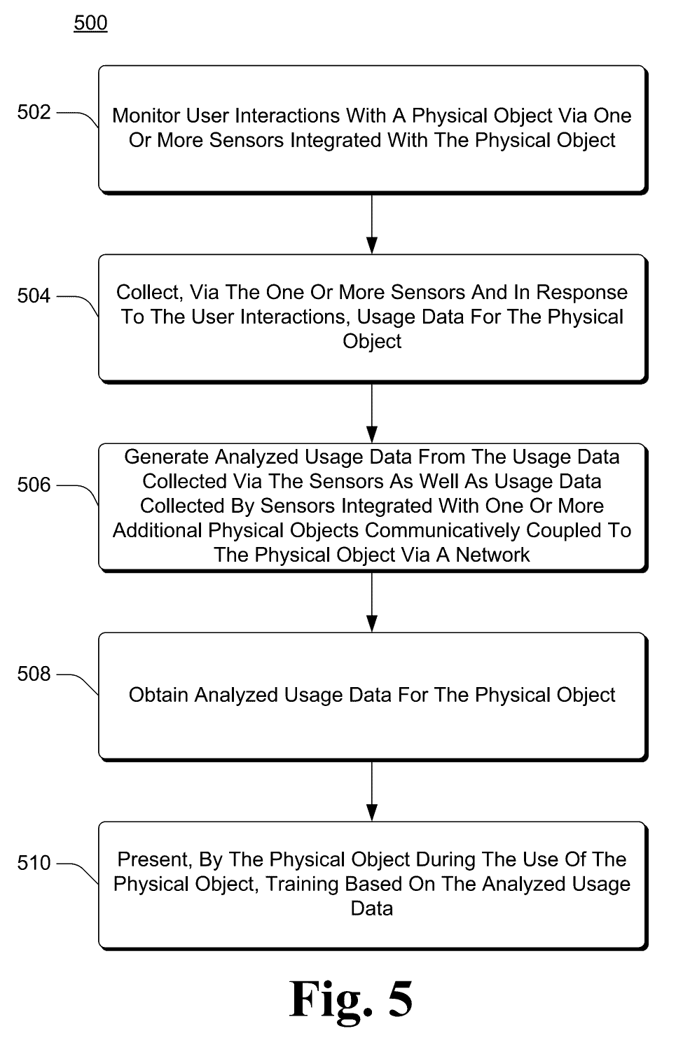

FIG. 5 is a flowchart illustrating an example process 500 for physical object training feedback based on object-collected usage data in accordance with one or more embodiments. The process 500 is carried out by one or more physical objects or computing devices such as those depicted in FIG. 1, 2, 3, or 4. The process 500 can be implemented in software, firmware, hardware, or combinations thereof. The process 500 is shown as a set of acts and is not limited to the order shown for performing the operations of the various acts. The process 500 is an example process for physical object training feedback based on object-collected usage data; additional discussions of physical object training feedback based on object-collected usage data are included herein with reference to different figures.

In the process 500, user interactions with a physical object are monitored via one or more sensors integrated with the physical object (act 502). Additionally or alternatively, the user interactions may be monitored by sensors integrated with other physical objects or computing devices that are communicatively connected with the sensors in the object with which the user is interacting.

In response to the user interactions, a usage data collection module collects and records the interaction data produced by the sensors (act 504). A communication interface may be used to facilitate transfer of usage data between the physical objects and/or other devices.

Analyzed usage data is generated from the usage data collected via the sensors as well as usage data collected by the sensors integrated with other physical objects or computing devices communicatively connected to the physical object with which the user is interacting (act 506). The analyzed usage data may be generated by a usage data analysis module integrated with the physical object for which the data was collected or by another module in a separate object or computing device.

The analyzed usage data for the physical object is obtained by a training feedback interface to generate training feedback for the user (act 508). The training feedback may be generated by the training feedback interface with the physical object for which the data was collected or by a training system/module in a separate component that is communicatively connected to the physical object with which the user is interacting.

Training feedback based on the analyzed usage data is presented to the user (act 510). The training feedback may be presented by the physical object or separate object or computing device that is communicatively connected to the physical object. Additionally, the training feedback may be presented in real-time, during the use of the physical object, after the use has ceased, or the training feedback may be presented in part during the use and in part after the use has ceased.

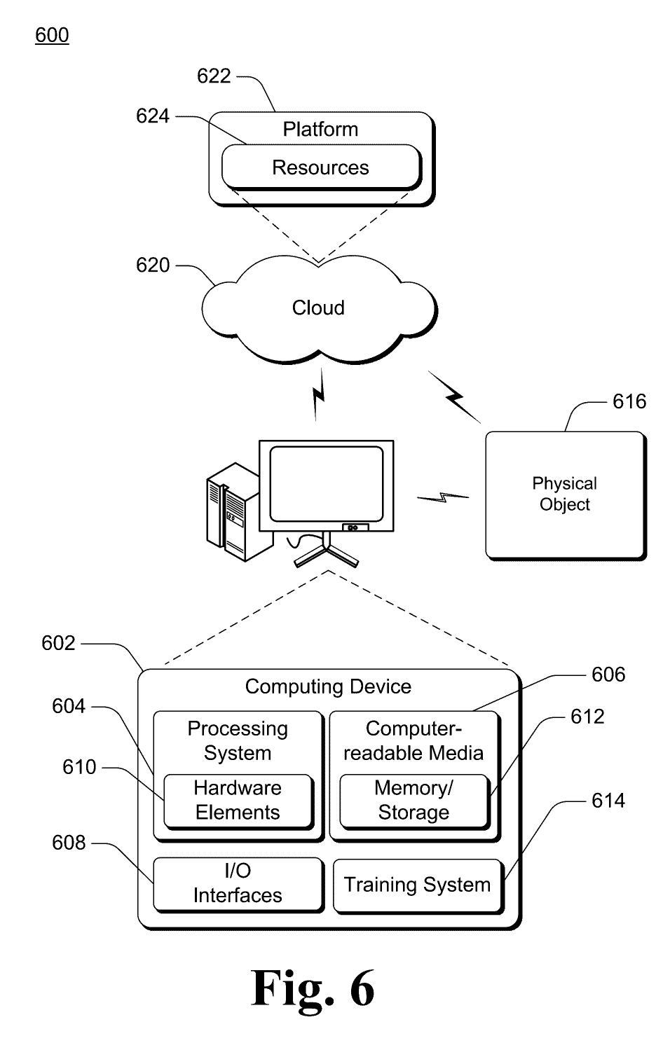

FIG. 6 illustrates an example system generally at 600 that includes an example computing device 602 that is representative of one or more computing systems and/or devices that may implement the various techniques described herein. This is illustrated through inclusion of the training system 614, which can be a training system such as the training system 110 of FIG. 1 or the training system 406 of FIG. 4. The physical object 616 can be any of the physical objects 102 of FIG. 1 or the physical object 400 of FIG. 4. The training system 614 is configured to analyze usage data associated with a user's interactions with a physical object and present the training feedback to the user. Additionally or alternatively, the training system 614 may receive analyzed usage data from another source, and send the analyzed usage data to the physical object 616 or another device or object, which may then present the training feedback directly to the user. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interfaces 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). Computer-readable media 606 may be configured in a variety of other ways as further described below.

Input/output interface(s) 608 are representative of functionality to allow a user to enter commands and information to the computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of the computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a “cloud” 620 via a platform 622 as described below.

The cloud 620 includes and/or is representative of a platform 622 for resources 624. The platform 622 abstracts underlying functionality of hardware (e.g., servers) and software resources of the cloud 620. The resources 624 may include applications and/or data that can be utilized while computer processing is executed on servers that are remote from the computing device 602. The resources 624 can also include services provided over the Internet and/or through a subscriber network, such as a cellular or Wi-Fi network.

The platform 622 may abstract resources and functions to connect computing device 602 with other computing devices. Platform 622 may also serve to abstract scaling of resources to provide a corresponding level of scale to encountered demand for resources 624 that are implemented via the platform 622. Accordingly, in an interconnected device embodiment, implementation of functionality described herein may be distributed throughout the system 600. For example, the functionality may be implemented in part on the computing device 602 as well as via the platform 622 that abstracts the functionality of the cloud 620.

While the foregoing has described the example system 600 as operating primarily through the computing device 602, all or some of the functions described may additionally or alternatively be performed by the example physical object 616 via a physical object training module integrated with the example physical object or with a separate object or computing device that is communicatively connected to the physical object 616.

Various actions performed by various interfaces, systems, and modules are discussed herein. A particular interface, system, or module discussed herein as performing an action includes that particular interface, system, or module itself performing the action, or alternatively that particular interface, system, or module invoking or otherwise accessing another component, interface, system, or module that performs the action (or performs the action in conjunction with that particular interface, system, or module). Thus, a particular interface, system, or module performing an action includes that particular interface, system, or module itself performing the action and/or another interface, system, or module invoked or otherwise accessed by the particular interface, system, or module performing the action.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a physical object, the method comprising:
monitoring user interactions with the physical object via one or more sensors integrated with the physical object;
collecting, via the one or more sensors and in response to the user interactions, usage data for the physical object;
obtaining analyzed usage data for the physical object, the analyzed usage data generated by analyzing the usage data collected via the one or more sensors as well as usage data for the physical object collected by one or more sensors integrated with one or more additional physical objects communicatively coupled to the physical object via a network; and
presenting, by the physical object in real-time during use of the physical object, training feedback generated based on the analyzed usage data.

2. The method of claim 1, further comprising evaluating the analyzed usage data by comparing the analyzed usage data for the physical object with benchmark data.

3. The method of claim 2, the benchmark data comprising aggregated analyzed usage data collected from multiple different users.

4. The method of claim 1, the usage data having been collected during the user interactions with the physical object.

5. The method of claim 1, further comprising analyzing the usage data during the user interactions with the physical object.

6. The method of claim 5, the presenting the training feedback comprising presenting the training feedback during the user interactions with the physical object.

7. The method of claim 1, further comprising analyzing the usage data after the user interactions with the physical object have stopped.

8. The method of claim 1, the presenting the training feedback comprising presenting the training feedback after the user interactions with the physical object have stopped.

9. The method of claim 1, the analyzing of the usage data being performed by the physical object.

10. A device comprising:
one or more sensors integrated with the device, the one or more sensors configured to monitor user interactions with the device and, in response to the user interactions, collect usage data for the device;
a communication interface, the communication interface configured to obtain analyzed usage data for the device, the analyzed usage data generated by analyzing the usage data collected via the one or more sensors as well as usage data for the device collected by one or more sensors integrated with one or more additional devices communicatively coupled to the device via a network; and
a training system, the training system configured to present, in real-time during the user interactions with the device, training feedback generated based on the analyzed usage data.

11. The device of claim 10, the training system further configured to evaluate the analyzed usage data by comparing the analyzed usage data for the device with benchmark data.

12. The device of claim 10, the usage data having been collected during the user interactions with the device.

13. The device of claim 10, the training system being further configured to analyze the usage data performed during the user interactions with the device.

14. The device of claim 13, the training system being further configured to present the training feedback during the user interactions with the device.

15. The device of claim 10, training system being further configured to analyze the usage data.

16. A device comprising:
one or more processors; and
one or more computer-readable storage media having stored thereon multiple instructions that, responsive to execution by the one or more processors, cause the one or more processors to:
obtain analyzed usage data for a physical object, the analyzed usage data generated by analyzing usage data collected by one or more sensors integrated with the physical object as well as usage data for the physical object collected by one or more sensors integrated with one or more other physical objects communicatively coupled to the device via a network; and
present training feedback generated based on the analyzed usage data.

17. The device of claim 16, the multiple instructions further causing the one or more processors to evaluate the analyzed the usage data by comparing the analyzed usage data for the physical object with benchmark data.

18. The device of claim 17, the usage data having been collected during the user interactions with the physical object.

19. The device of claim 16, the multiple instructions further causing the one or more processors to analyze the usage data during user interactions with the physical object.

20. The device of claim 19, the multiple instructions further causing the one or more processors to present the training feedback during user interactions with the physical object.
